(19) United States
(12) Patent Application Publication
(10) Pub. No.: US 2002/0191528 A1
(43) Pub. Date: Dec. 19, 2002

(54) Optical disk recording/reproducing device and operating method

(76) Inventor: Satoshi Sugaya, Tokyo (JP)

Correspondence Address: Norman P. Soloway, HAYES SOLOWAY P.C., 130 W. Cushing Street, Tucson, AZ, 85701, US

(21) Appl. No.: 10/215,220

(22) Filed: Aug. 7, 2002

Related U.S. Application Data
(63) Continuation of application No. 09/513,763, filed on Feb. 25, 2000.

(30) Foreign Application Priority Data
Mar. 4, 1999 (JP) 057001/1999

(51) Int. Cl. G11B 21/08; G11B 7/085; G11B 17/22; G11B 17/04; G11B 17/08; G11B 17/00; G11B 21/16

(52) U.S. Cl. 369/197; 369/30.28; 369/30.2; 369/30.85; 369/249

(57) ABSTRACT

A plurality of optical disks 2 and 3 are housed inside one cartridge 1. Cartridge 1 containing a plurality of optical disks 2 and 3 is loaded. Inside the optical disk recording/reproducing device, the two optical disks 2 and 3 inside cartridge 1 are mounted on two turntables and rotated, the two optical disks both being accessible by a single optical head, thereby enabling a recording time that is two or more times that of the prior art and free of any interruptions.

### BACKGROUND OF THE INVENTION

1. Field of the Invention

The present invention relates to an optical disk recording/reproducing device and a method of operating the device, and particularly to an optical disk recording/reproducing device for recording and reproducing with respect to two or more optical disks and a method of operating the device.

2. Description of the Related Art

An optical disk allows extremely high recording density, data being recorded and reproduced by using an objective lens to focus a laser beam to the diffraction limit on the wavelength order and directing the beam onto the surface of an optical disk recording layer. Since light is employed to record and reproduce data on an optical disk, the optical disk and optical head are always out of contact and the reliability of information is high.

Optical disks are further largely unaffected by dust or dirt on the substrate surface because the incident laser beam passes through a transparent substrate. Optical disks can be exchanged and can also be easily carried. Because they offer these advantages, optical disks are the subject of much research and development, and many products have been developed and are coming into wide use. In particular, many advances have been achieved in recent years in the development of high-density, large-capacity optical disks. DVD-RAM, which is a rewritable optical disk that only recently came onto the market, has a recording capacity of 2.6 GB in a single optical disk 120 mm in diameter, and thus features four times the capacity of a conventional CD-ROM. Despite the great capacity of optical disks, however, no more than one hour's worth of image data according to Moving Picture Experts Group 2 (MPEG2) can be recorded on a disk, and an entire movie therefore cannot be accommodated on a single disk. A plurality of optical disks are thus required to record and reproduce a movie, an important form of multimedia data, and a plurality of optical disks must be removed and inserted from the optical disk recording/reproducing device during recording or reproducing. This necessity is extremely inconvenient for the user and poses a serious obstacle to the popularization of this medium.

In response to this problem, the next generation of rewritable optical disks in which a single optical disk features a storage capacity in the 5-GB class are now being developed through the use of signal processing technology and recording/reproduction technology. When recording and reproducing image data having a long recording time or high-definition image data such as “Hi-vision,” however, the data must still be recorded onto a plurality of optical disks and a plurality of optical disks must still be removed and inserted into the optical disk recording/reproducing device. According to one known method, a doubled capacity can be realized by bonding together two optical disks and then using the obverse and reverse sides. To avoid the necessity of removing and reinserting such a disk, however, two optical heads must be provided, one for the obverse side and one for the reverse side of the optical disk, or a mechanism is required to allow a single optical head to access both the obverse and reverse sides of the optical disk. Either case entails higher costs and a more complex mechanism, and in addition, presents difficulties in regard to achieving a slimmer construction.

A method of doubling capacity by providing a double-layered recording layer that allows access from one side is also being investigated. However, this method will most likely be difficult to put to practical use with high recording density due to the issues of light utilization and performance. In this regard, an optical disk recording/reproducing device is being developed in which recording/reproducing with respect to each of two optical disks can be performed by first accommodating two optical disks inside a cartridge and then inserting the cartridge into the optical disk recording/reproducing device, wherein the optical disks are automatically switched. Such an optical disk recording/reproducing device is described in, for example, Japanese Patent Application No. 295630/97 “Optical Disk Recording/Reproducing Device.” However, this case of the prior art has the following problems. First, when switching between the two optical disks inside an optical disk recording/reproducing device in which two optical disks are inserted, some time passes from the time the recording/reproducing of one optical disk ends until recording/reproducing can be performed on the other optical disk, and the recording/reproduction of information is therefore interrupted when switching optical disks. This interruption occurs because, when exchanging optical disks in the optical disk recording/reproducing device, recording/reproduction on the next optical disk becomes possible only after removing the servo from the optical disk for which recording/reproducing was being performed, then stopping the rotation of the spindle motor, removing the optical disk from the turntable, mounting the other optical disk on the turntable, starting rotation of the spindle motor, and finally applying the servo to the other optical disk. In such a case, at least 10 seconds is required from the time recording/reproducing of one optical disk ends until recording/reproducing is possible on the other optical disk. The serious problem therefore exists that recording/reproducing of data is impossible during this interval, and recording/reproducing of information is interrupted.

Regarding the second problem, the incorporation of a buffer memory can be considered that is greater than the time for exchanging the optical disks so as to enable continuous recording/reproducing without interruption of the recording/reproduction of information when the optical disks are being switched. In such a case, however, the incorporation of a large-capacity buffer memory entails the problem of increased cost. If a time interval of 10 seconds is needed from the end of recording/reproducing of one optical disk until recording/reproducing of the other optical disk is possible and the transfer rate is, for example, 16 Mbps, a memory of at least 20 MB is necessary. A memory of this great a capacity is expensive and inevitably affects the price of the product.

The third problem is that incorporation of two optical heads entails higher cost, a more complex control system, and a larger apparatus. A method of realizing a single optical disk recording/reproducing device by providing two spindle motors as well as two optical heads and arranging these components as two sets of optical disk drives can be considered as a means of eliminating the time for exchanging optical disks. In this case, not only can the time for exchanging optical disks be eliminated, but the data transfer rate can also be increased by performing recording/reproducing simultaneously at the two optical heads. This method, however, entails severe problems due to the need for an additional and costly optical head, the increase in cost for the accompanying circuitry, and the complexity of the control system for two optical heads. It is therefore preferable to minimize the interruption that occurs when using a single optical head for recording/reproducing the content of two optical disks.

### SUMMARY OF THE INVENTION

It is an object of the present invention to provide an optical disk recording/reproducing device and operating method that minimize interruptions when using a single optical head to record and reproduce the content of two optical disks.

It is another object of the present invention to provide an optical disk recording/reproducing device and operating method that: can minimize interruptions in reproduction when using a single optical head to reproduce the recorded content of two optical disks; that is smaller and slimmer; that is capable of higher speed; that has a simplified device structure; and that improves reliability, operability, and productivity.

The optical disk recording/reproducing device of the present invention is made up of: a first transport device for moving a plurality of optical disks; turntables for holding each of a plurality of optical disks that are moved by the first transport device; an optical head; and a second transport device for moving the optical head between a plurality of optical disks on the turntables. The optical head, which is moved by the second transport device, can access one disk and then the other by moving quickly between the plurality of optical disks, and thus can record and reproduce the recorded content of each of the plurality of optical disks in a substantially continuous manner.

In addition, a cartridge for housing a plurality of optical disks, and a third transport device for moving the cartridge are also preferably provided. In this case, a loading device is provided for inserting and ejecting a cartridge. A slim structure is possible if the plurality of optical disks is arranged on turntables on the same plane. The optical head is arranged on the same side of the plurality of optical disks as the turntables. In the interest of providing a slimmer construction, the optical head preferably moves in the radial direction of the plurality of optical disks on the turntables.

Arrangement of the plurality of optical disks on turntables in a plurality of differing planes and movement of the optical head in the radial direction of the optical disks are advantageous for realizing a slimmer and more compact construction.

The operating method of the optical disk recording/reproducing device according to the present invention is an operating method of a cartridge of an optical disk recording/reproducing device, the optical disk recording/reproducing device being made up of a first transport device for moving a plurality of optical disks, a plurality of turntables for holding each of a plurality of optical disks that are moved by the first transport device, an optical head, and a second transport device for moving the optical head between the plurality of optical disks on the turntables; and comprises the steps of: inserting a cartridge that houses a plurality of optical disks; mounting a plurality of optical disks on a plurality of turntables; ejecting the empty cartridge to the outside; inserting an empty cartridge when removing the plurality of optical disks; and ejecting to the outside a cartridge in which a plurality of optical disks have been inserted. Any number of optical disks can be continuously reproduced.

The operating method of the optical disk recording/reproducing device according to the present invention may further comprise the steps of: inserting a cartridge housing three or more optical disks; removing two optical disks from the cartridge and mounting the disks on two turntables; and performing recording/reproducing of the two optical disks by a single optical head. It is particularly preferable that the method comprise another step of exchanging the positions of the other two optical disks while recording/reproducing is performed on one optical disk. This mode enables continuous reproduction of three or more disks. In addition to reproduction, substantially continuous recording is also possible.

By loading a cartridge accommodating two optical disks in an optical disk recording/reproducing device in this way, a user can record or reproduce twice the capacity of the prior art with the same sensation to the user as handling a single optical disk of the prior art. The invention eliminates the need to spend time to exchange optical disks and further eliminates interruptions that occur when exchanging optical disks. Furthermore, any number of optical disks can be continuously recorded or reproduced without interruptions by: accommodating three or more optical disks in a magazine-type cartridge; inserting the cartridge in an optical disk recording/reproducing device; always keeping two of these optical disks mounted on two turntables; and exchanging other optical disks while recording/reproducing one of the optical disks that are mounted on the turntables.

The above objects, features, and advantages of the present invention will become apparent from the following description based on the accompanying drawings which illustrate examples of preferred embodiments of the present invention.

### BRIEF DESCRIPTION OF THE DRAWINGS

FIG. 1 is a perspective view showing an embodiment of the optical disk recording/reproducing device according to the present invention.

FIG. 2 is a sectional view of the optical disk recording/reproducing device of FIG. 1.

FIG. 3 is a perspective view showing the relation between the cartridge and optical disks of the optical disk recording/reproducing device.

FIG. 4 is a perspective view showing another relation between the cartridge and optical disks of the optical disk recording/reproducing device.

FIG. 5 is a plan view showing another relation between the cartridge and optical disks of the optical disk recording/reproducing device.

FIG. 6 is a plan view showing another relation between the cartridge and optical disks.

FIG. 7 is a front sectional view showing yet another relation between the cartridge and optical disks.

FIG. 8 is a perspective view showing yet another relation between the cartridge and optical disks of the optical disk recording/reproducing device.

FIG. 9a, FIG. 9b, FIG. 9c, FIG. 9d, FIG. 9e, and FIG. 9f are each frontal sectional views showing each of the different operations of the optical disk recording/reproducing device.

FIG. 10a and FIG. 10b are a plan view and front view showing the positional relation between two optical disks and two turntables of the optical disk recording/reproducing device.

FIG. 11a and FIG. 11b are a plan view and front view showing another positional relation between the two optical disks and two turntables of the optical disk recording/reproducing device.

FIG. 12a and FIG. 12b are a plan view and front view showing yet another positional relation between the two optical disks and two turntables of the optical disk recording/reproducing device.

FIG. 13a and FIG. 13b are a plan view and front view showing yet another positional relation between the two optical disks and two turntables of the optical disk recording/reproducing device.

FIG. 14a and FIG. 14b are a plan view and front view showing yet another positional relation between the two optical disks and two turntables of the optical disk recording/reproducing device.

FIG. 15a and FIG. 15b are a plan view and front view showing yet another positional relation between the two optical disks and two turntables of the optical disk recording/reproducing device.

FIG. 16a and FIG. 16b are a plan view and front view showing yet another positional relation between the two optical disks and two turntables of the optical disk recording/reproducing device.

FIG. 17a and FIG. 17b are a plan view and front view showing yet another positional relation between the two optical disks and two turntables of the optical disk recording/reproducing device.

FIG. 18a and FIG. 18b are a plan view and front view showing yet another positional relation between the two optical disks and two turntables of the optical disk recording/reproducing device.

FIG. 19a and FIG. 19b are a plan view and front view showing yet another positional relation between the two optical disks and two turntables of the optical disk recording/reproducing device.

FIG. 20a and FIG. 20b are a plan view and front view showing yet another positional relation between the two optical disks and two turntables of the optical disk recording/reproducing device.

FIG. 21a and FIG. 21b are a plan view and front view showing yet another positional relation between the two optical disks and two turntables of the optical disk recording/reproducing device.

FIG. 22a, FIG. 22b, FIG. 23c, and FIG. 22d are a sectional view, a sectional view, a plan view, and a sectional view, respectively, showing additional positional relations between the two optical disks and two turntables of the optical disk recording/reproducing device.

FIG. 23a and FIG. 23b are sectional views, each showing yet another positional relation between the two optical disks and two turntables of the optical disk recording/reproducing device.

### DETAILED DESCRIPTION OF THE PREFERRED EMBODIMENTS

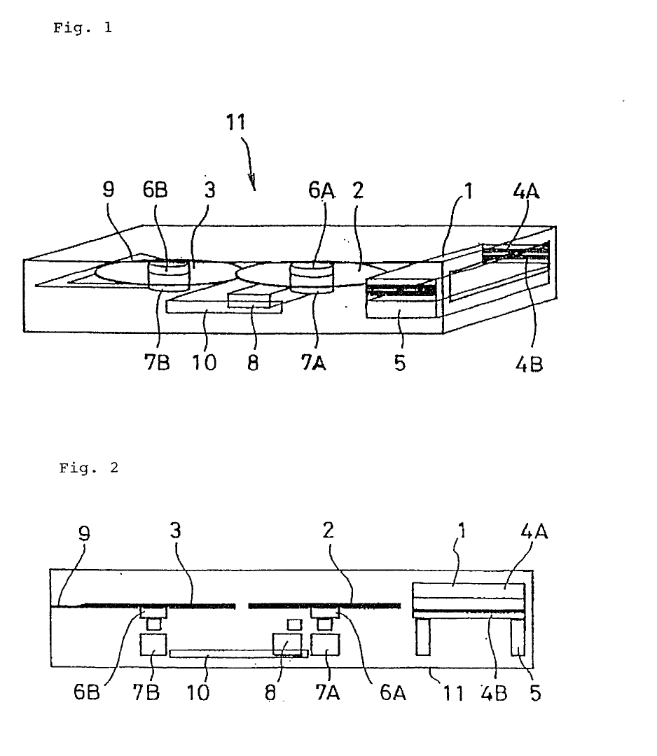

Embodiments of the optical disk recording/reproducing device according to the present invention are next described with reference to the accompanying figures. Each embodiment is provided with both a cartridge and two optical disks. As shown in FIG. 1, optical disk recording/reproducing device 11 is provided with cartridge 1, two optical disks 2 and 3 being housed inside cartridge 1. Optical disks 2 and 3 are supported inside cartridge 1 by two pairs of rails 4A and 4B.

As shown in FIG. 2, optical disk recording/reproducing device 11 is further provided with: two turntables 6A and 6B for mounting two optical disks, spindle motors 7A and 7B, optical head 8, positioner 10, optical disk transport device 9, and cartridge raising/lowering device 5. Turntables 6A and 6B are supported and driven by spindle motors 7A and 7B. Optical head 8 is capable of recording data to optical disks 2 and 3 and reproducing data from optical disks 2 and 3 by accessing two optical disks 2 and 3. Positioner 10 is a drive device for moving optical head 8 that accesses the two optical disks. Optical disk transport device 9 is a transport device for moving optical disks 2 and 3 between cartridge 1 and over turntables 6A and 6B, and moves optical disks 2 and 3 by clasping the disks. Cartridge raising/lowering device 5 is capable of positioning cartridge 1 by raising and lowering the cartridge.

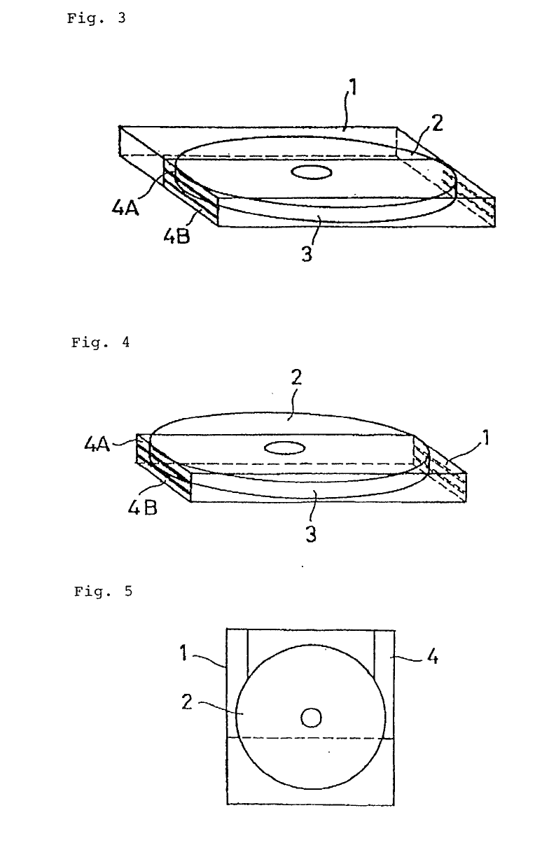

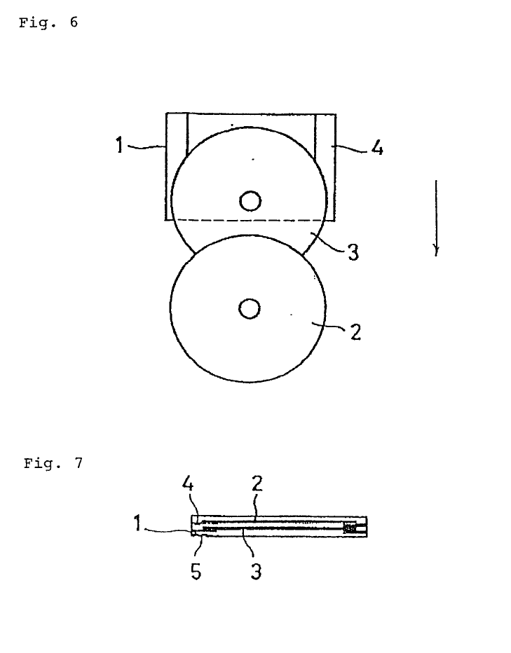

As shown in FIGS. 3, 5, and 7, two optical disks 2 and 3 are housed inside cartridge 1. The two optical disks 2 and 3 are mounted on rails 4A and 4B, respectively, provided inside cartridge 1. An access window (not shown), which is closed when optical disks 2 and 3 are outside of and not inserted into optical disk recording/reproducing 11, prevents dust or dirt from entering cartridge 1. FIG. 4 shows the state when optical disks 2 and 3 are inserted in optical disk recording/reproducing device 11 and cartridge 1 is open; FIG. 5 shows the state when cartridge 1 is closed when optical disks 2 and 3 are not inserted in optical disk recording/reproducing device 11; and FIG. 6 shows the state when optical disks 2 and 3 are inserted in optical disk recording/reproducing device 11, cartridge 1 is open, and upper optical disk 2 is being drawn out [from cartridge 1].

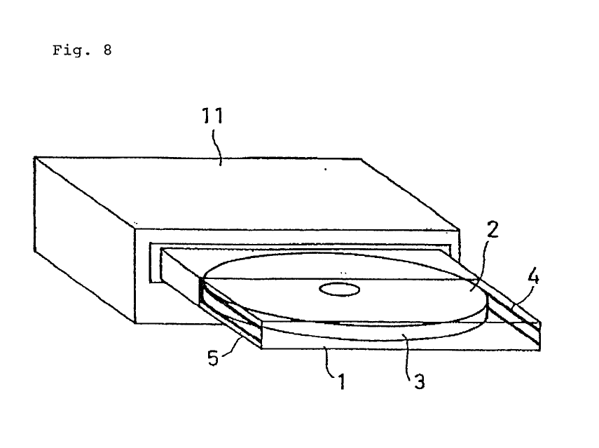

When cartridge 1 is inserted in optical disk recording/reproducing device 11 as shown in FIG. 8, the access window of cartridge 1 opens and two optical disks 2 and 3 can be grasped by optical disk transport device 9, as shown in FIGS. 4 and 6. FIG. 9 shows operations when mounting two optical disks 2 and 3 on two turntables 6A and 6B, respectively, and performing recording/reproducing with respect to each of the optical disks after cartridge 1 has been inserted into optical disk recording/reproducing device 11. As shown in FIG. 9a, cartridge 1, which houses two optical disks 2 and 3, is inserted into optical disk recording/reproducing device 11. Cartridge 1 is set over cartridge raising/lowering device 5 by the loading device comprising cartridge raising/lowering device 5 and optical transport device 9, as shown in FIG. 9b. At this time, the access window of cartridge 1 is opened by the loading device, thereby allowing the two optical disks 2 and 3 to be withdrawn from or inserted into cartridge 1.

Cartridge raising/lowering device 5 moves cartridge 1 up or down to facilitate extraction of the optical disk to which recording/reproducing is to be performed and determines the vertical position of cartridge 1. Cartridge raising/lowering device 5 positions cartridge 1 at a lower position when upper optical disk 2 is to be withdrawn or inserted, and positions cartridge 1 at an upper position when lower optical disk 3 is to be withdrawn or inserted.

In FIG. 9b, cartridge raising/lowering device 5 positions cartridge 1 at the lower position for withdrawal of upper optical disk 2. As shown in FIG. 9c, optical disk transport device 9 moves in a direction parallel to the plane of the optical disk to a position allowing grasping of optical disk 2 that is mounted on rails 4A inside cartridge 1, in which the access window is open, and clasps and holds optical disk 2, which is to be withdrawn, by both sides.

As shown in FIG. 9d, optical disk transport device 9 then moves in a direction parallel to the disk surface to move the held optical disk 2 to a position allowing mounting on turntable 6A, and clamps optical disk 2 to turntable 6A. At this time, rails 4A and 4B, which support the two optical disks 2 and 3 inside cartridge 1, may have a width sufficient only for allowing support of the outermost edge portions of the optical disks; and optical disk transport device 9 has a structure that grasps the optical disks by clasping the side edge surfaces of the optical disks, thereby avoiding damage to the optical disk data surface, to which recording/reproducing is carried out, when moving optical disk 2.

As shown in FIG. 9e, cartridge raising/lowering device 5 next moves cartridge 1 to the upper position. Optical disk transport device 9 clasps optical disk 3 from both sides and holds optical disk 3. Next, as shown in FIG. 9f, optical disk transport device 9 moves in a direction parallel to the disk surface to a position allowing mounting of held optical disk 3 to turntable 6B, and mounts optical disk 3 on turntable 6B.

The two spindle motors 7A and 7B next commence rotation. When two optical disks 2 and 3 are rotating, positioner 10 moves optical head 8 to enable [optical head 8] to access two optical disks 2 and 3. When carrying out recording/reproducing of one optical disk 3 after stopping recording/reproducing of the other optical disk 2, positioner 10 moves optical head 8 from optical disk 2 to optical disk 3. The switching time required for this movement is extremely short, with almost no interruption time during reproduction, thereby enabling substantially continuous recording/reproducing. In addition, the ending of recording/reproducing and return of two optical disks 2 and 3 to cartridge 1 is carried out in the reverse order of the above-described operations.

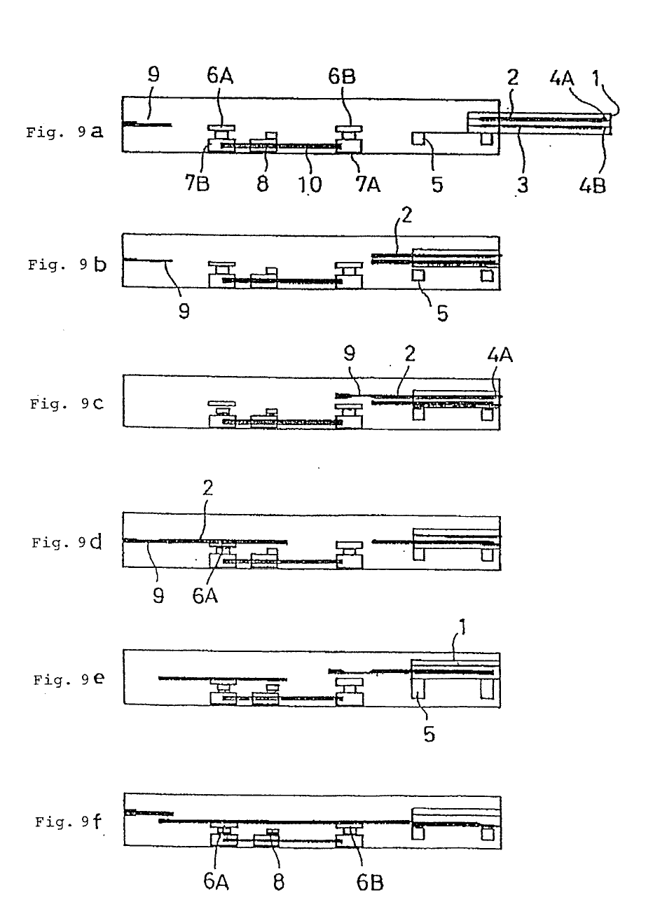

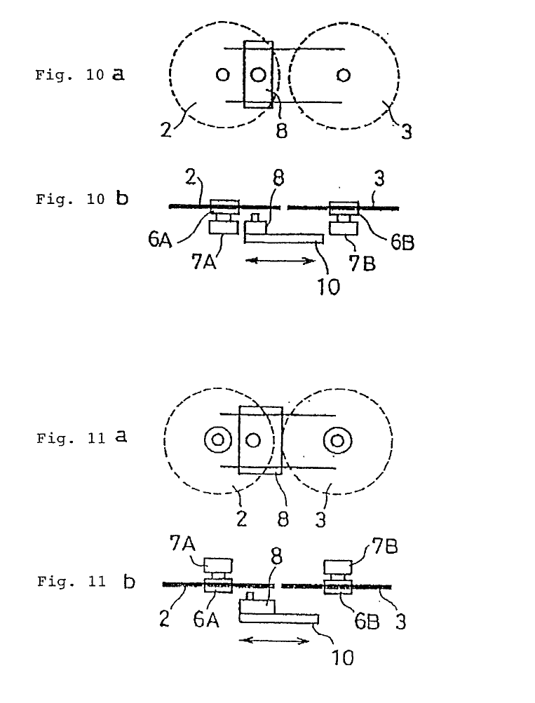

FIGS. 10-13 show another embodiment of the optical disk recording/reproducing device of the present invention, and show the relation of two optical disks 2 and 3 and one optical head 8 that accesses both of these optical disks 2 and 3. In the state of the embodiment shown in FIG. 10a and FIG. 10b, two optical disks 2 and 3 are arranged on the same plane, and optical head 8 is able to access two optical disks 2 and 3 by means of one positioner 10.

In this case, optical head 8 must be made thin to avoid interference with the two spindle motors 7A and 7B when performing recording/reproducing of the innermost circumference of each of two optical disks 2 and 3. Although the problem exists that the stroke for movement of optical head 8 by positioner 10 must be twice that of the prior art, there is the advantage that almost no time is required when switching recording/reproducing from one optical disk to the other optical disk, this time being substantially equal to the access time within one optical disk.

The mode of the embodiment shown in FIG. 11a and FIG. 11b is the same as the mode of the embodiment shown in FIG. 10a and FIG. 10b in that two optical disks 2 and 3 are arranged on the same plane, but differs in that optical head 8 is arranged on the opposite side of optical disks 2 and 3 from spindle motors 7A and 7B. The use of optical disks that are bonded together in this embodiment has the problems that accuracy is required in bonding, and the stroke of movement of optical head 8 by positioner 10 is twice that of the prior art, but has the advantages that more freedom in the size of optical head 8 is possible because interference with the two spindle motors 7A and 7B is avoided, and almost no time is required for switching recording/reproducing from one optical disk to the other optical disk, this time being substantially equivalent to the access time within one optical disk.

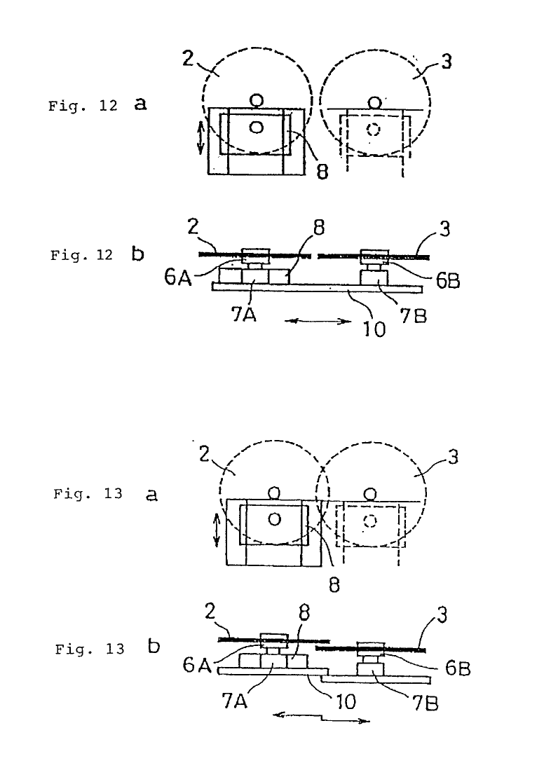

The embodiment shown in FIG. 12a and FIG. 12b is the same as the embodiment shown in FIGS. 10a and 10b in that two optical disks 2 and 3 are arranged on the same plane, but differs from the above-described embodiment in that optical head 8 is able to access two optical disks 2 and 3 by moving in a direction parallel to optical disks 2 and 3 as a unit with positioner 10. Although there is the problem that the size of the device increases in this case because it additional requires a transport mechanism for positioner 10, it has the advantage of allowing the appropriation of optical head 8 and positioner 10 of the prior art without need for alteration.

In the embodiment shown in FIG. 13a and FIG. 13b, the two optical disks are arranged on different planes and optical head 8 is able to access two optical disks 2 and 3 by moving as a unit with positioner 10. Although there is the problem that the size of the device increases in this case because it additionally requires a transport mechanism for positioner 10, this arrangement allows a smaller footprint than the embodiment of FIG. 12a and FIG. 12b because one of two optical disks 2 and 3, which are on different planes, can superpose the other. In addition, optical head 8 and positioner 10 of the prior art can be appropriated without any need for alteration in composition. Different embodiments are next described regarding the relation between cartridge 1, which houses two optical disks 2 and 3, and two optical disks 2 and 3 mounted on two turntables 6A and 6B. In the embodiment shown in FIG. 14a and FIG. 14b, two optical disks 2 and 3 are both removed from cartridge 1 in a horizontal direction and disposed on the same plane.

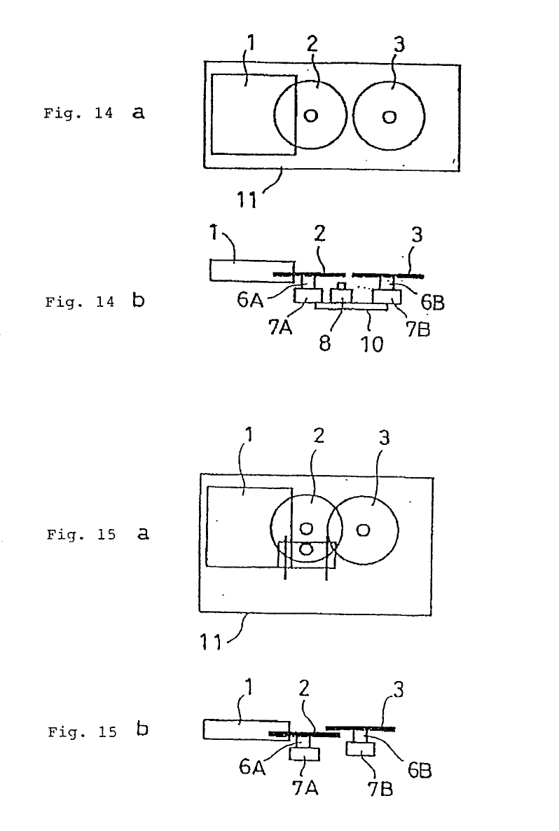

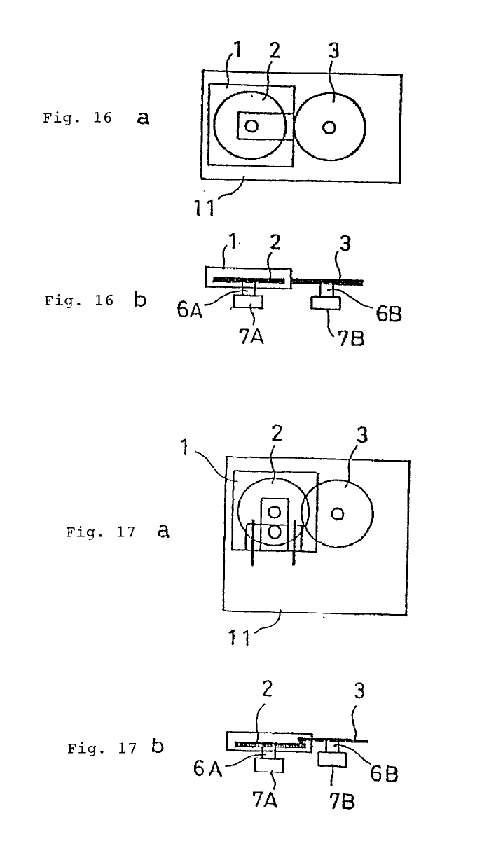

In the embodiment shown in FIG. 15a and FIG. 15b, two optical disks 2 and 3 are both removed from cartridge 1 in a horizontal direction and disposed on different planes. Parallel removal of two optical disks 2 and 3 from cartridge 1 and arrangement of each optical disk on the plane in which it was removed can eliminate the need for raising/lowering device 5 for cartridge 1 [NOTE: This component was previously referred to as “cartridge raising/lowering device 5.” Please check.]. In the embodiment shown in FIG. 16a and FIG. 16b, the two optical disks are arranged in the same plane with each mounted on a respective turntable 6A and 6B in a state in which only one of two optical disks 2 and 3 is removed in a horizontal direction and the other optical disk is left inside cartridge 1. Although this configuration has the problem that a shutter is required so that the access window opens to enable mounting of cartridge 1 on a turntable and access by optical head 8, it has the advantage of reducing the footprint of the device.

In the embodiment shown in FIG. 17a and FIG. 17b, each of optical disks 2 and 3 are arranged on different planes and mounted on a respective turntable 6A and 6B in a state in which only one of two optical disks 2 and 3 is removed in a horizontal direction and the other optical disk is left inside cartridge 1. Although this configuration has the problem that a shutter is required so that the access window opens to enable mounting of cartridge 1 on a turntable and access by optical head 8, it has the advantage of reducing the footprint of the device.

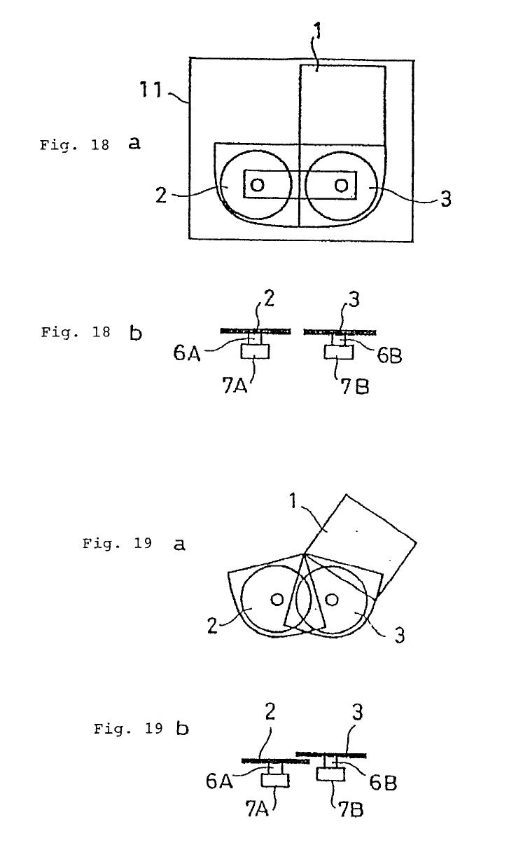

Although a horizontal removal type is shown as the method of withdrawing two optical disks 2 and 3 in the embodiments shown in FIGS. 4a through 17b, a rotating removal type, in which trays in which optical disks are mounted are rotated and removed, is next shown. In the embodiment shown in FIG. 18a and FIG. 18b, two optical disks 2 and 3 are both removed from cartridge 1 in the direction of rotation and arranged on the same plane. In FIGS. 19a and 19b, two optical disks 2 and 3 are both removed from cartridge 1 in the direction of rotation and arranged on different planes. Removal of the two optical disks from cartridge 1 by rotating and leaving each optical disk on the same plane as removal without alteration can eliminate the need for “cartridge raising/lowering device 5.

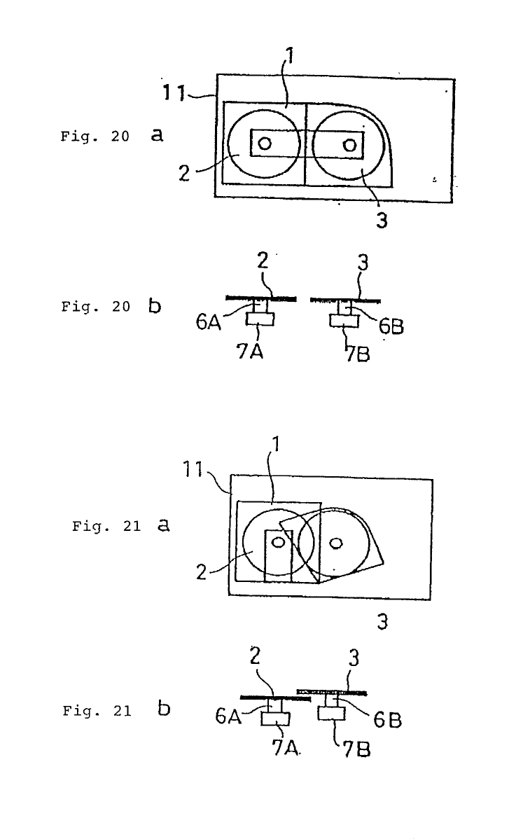

In the embodiment shown in FIG. 20a and FIG. 20b, each optical disk is arranged in the same plane and mounted on a respective turntable 6A and 6B in a state in which only one of two optical disks 2 and 3 is removed in the direction of rotation and the other optical disk is left inside cartridge 1. Although this configuration has the problem that a shutter is required so that the access window opens to enable mounting of cartridge 1 on a turntable and access by optical head 8, it has the advantage of reducing the footprint of the device.

In the embodiment shown in FIG. 21a and FIG. 21b, each optical disk is arranged on a different plane and mounted on a respective turntable 6A and 6B in a state in which only one of two optical disks 2 and 3 is removed in the direction of rotation and the other optical disk is left inside cartridge 1. Although this configuration has the problem that a shutter is required so that the access window opens to enable mounting of cartridge 1 on a turntable and access by optical head 8, it has the advantage of reducing the footprint of the device.

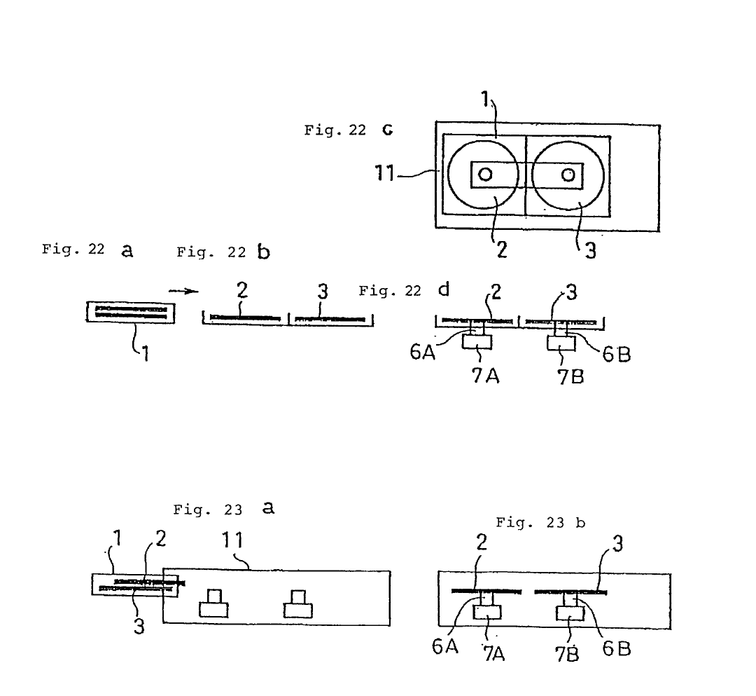

FIG. 22a and FIG. 22b show yet another embodiment, and show the relation between cartridge 1, which houses two optical disks 2 and 3, and two optical disks 2 and 3 mounted on two turntables 6A and 6B. Cartridge 1 housing two optical disks 2 and 3 as shown in FIG. 22a is opened such that each optical disk is housed individually as shown in FIG. 22b, and two optical disks 2 and 3 are then mounted on two turntables 6A and 6B, respectively, by insertion into optical disk recording/reproducing device 11 as shown in FIGS. 22c and 22d. Although this form has the problem that the user must open the cartridge, it has the advantage of eliminating the need for cartridge raising/lowering device 5.

FIGS. 23a and 23b show yet another embodiment and show the relation between cartridge 1, which houses two optical disks 2 and 3, and optical disks 2 and 3 mounted on turntables 6A and 6B, respectively. Cartridge 1, in which two optical disks 2 and 3 are housed, is inserted into optical disk recording/reproducing device 11, two optical disks 2 and 3 are mounted on turntables 6A and 6B, respectively, following which cartridge 1 is ejected from optical disk recording/reproducing device 11. When removing two optical disks 2 and 3, empty cartridge 1, in which optical disks are not housed, is inserted into optical disk recording/reproducing device 11, the two optical disks 2 and 3 are removed from respective turntables 6A and 6B and stored inside cartridge 1, and cartridge 1 in which two optical disks 2 and 3 are now housed is then ejected from optical disk recording/reproducing device 11. Although this form has the problem that ejected empty cartridge 1 must be removed when inserting the optical disks and empty cartridge 1 must be inserted into optical disk recording/reproducing device 11 when removing the optical disks, it has the advantage of enabling an overall reduction in the size of the device.

The present invention can be applied to three or more optical disks. Yet another embodiment of the present invention, which performs continuous recording/reproduction of data without interruptions, is described hereinbelow. Three or more optical disks are held inside magazine-type cartridge 1 and inserted into optical disk recording/reproducing device 11, whereupon two optical disks are withdrawn from cartridge 1 and mounted on two turntables 6A and 6B, following which the two optical disks are rotated and data recording/reproducing is performed with both optical disks accessible by one optical head 8. When data recording/reproducing is carried out with respect to one optical disk in this case, the other optical disk can be exchanged with another optical disk, thereby enabling data recording/reproducing with respect to three or more optical disks continuously and without interruption and without any need for the user to remove and insert optical disks.

Further, data recording/reproducing can be carried out with respect to one optical disk as in the prior art by housing only one optical disk inside cartridge 1 and inserting cartridge 1 into optical disk recording/reproducing device 11 of this invention, whereupon the optical disk is mounted on one of the turntables and data recording/reproducing is carried out by the optical head.

The optical disk recording/reproducing device and operating method of the present invention as explained hereinabove, exhibits the following effects. The first effect is enabling continuous recording/reproduction of twice the recording capacity of the prior art without any interruption in the recording/reproducing operation but with the same sensation to the user as handling one optical disk of the prior art. This effect is possible because two optical disks are housed inside a cartridge and the two optical disks are each mounted on a respective one of two turntables inside the optical disk recording/reproducing device, following which the two optical disks are both rotated with the two optical disks accessible by one optical head, thereby enabling continuous recording/reproducing of twice the capacity of the prior art without any interruption in the recording/reproducing operation when switching between optical disks.

The second effect is that, although various modes of doubling capacity can be considered, the present invention allows use of the prior art without need for alteration, enables easy compatibility, and moreover, enables a more compact and slimmer device at a low cost. This effect is realized because the present invention allows two optical disks to be accessed by a single optical head, thereby eliminating the need for two optical heads, eliminating the need for a double-sided optical disks having recording layers on both sides, and enabling use of single-sided optical disks of the prior art having a recording layer on only one side. The prior art can thus be used without any alteration, thereby allowing easy compatibility, lower cost, and a more compact and slimmer design.

As a third effect, the present invention enables continuous recording/reproduction of data spanning a plurality of optical disks without requiring the user to remove and insert optical disks and without any interruptions, even in cases requiring three or more optical disks. This effect can be realized because three or more optical disks are held inside a magazine-type cartridge and the cartridge is inserted in an optical disk recording/reproducing device of the present invention, whereupon two of the optical disks are withdrawn from the cartridge and mounted on two turntables, following which the two optical disks are rotated and recording/reproduction of data is carried out, both optical disks being accessible by a single optical head. Here, when data recording/reproducing is being performed with respect to one optical disk, the other optical disk can be exchanged with another optical disk, whereby continuous data recording/reproduction can be carried out with respect to three or more optical disks without interruptions and without any need for the user to remove and insert optical disks.

As the fourth effect of the present invention, the capacity of the buffer memory can be decreased and manufacturing costs can be reduced. When performing data recording/reproducing with respect to a plurality of optical disks, a buffer memory generally must be provided that has a capacity of at least the time for switching the optical disks in order to perform data recording/reproducing without interruptions. The present invention, however, enables switching of optical disks in which recording/reproducing with respect to a plurality of optical disks can be carried out by merely moving the optical head, thereby enabling a reduction of the capacity of the buffer memory and reducing the product cost.

While preferred embodiments of the present invention have been described using specific terms, such description is for illustrative purposes only, and it is to be understood that changes and variations may be made without departing from the spirit or scope of the following claims.

What is claimed is:

1. An optical disk recording/reproducing device comprising:
first transport device for moving a plurality of optical disks;
turntables for holding each of said plurality of optical disks that are moved by said first transport device;
an optical head; and
a second transport device for moving said optical head between a plurality of optical disks on said turntables.

2. An optical disk recording/reproducing device according to claim 1, further comprising:
a cartridge for housing said plurality of optical disks; and
a third transport device for moving said cartridge.

3. An optical disk recording/reproducing device according to claim 2, further comprising a loading device for inserting and ejecting said cartridge.

4. An optical disk recording/reproducing device according to claim 1 wherein said plurality of optical disks are arranged on said turntables in the same plane.

5. An optical disk recording/reproducing device according to claim 4 wherein said optical head is arranged on the same side said of said plurality of optical disks as said turntables.

6. An optical disk recording/reproducing device according to claim 1 wherein said optical head moves in a radial direction of said plurality of optical disks on said turntables.

7. An optical disk recording/reproducing device according to claim 1 wherein:
said plurality of optical disks are arranged on said turntables in a plurality of different planes; and
said optical head moves in a radial direction of said optical disks.

8. A method of operating a cartridge of an optical disk recording/reproducing device, said optical disk recording/reproducing device comprising a first transport device for moving a plurality of optical disks, a plurality of turntables for holding each of said plurality of optical disks that are moved by said first transport device, an optical head, and a second transport device for moving said optical head between a plurality of optical disks on said turntables; comprising steps of:
inserting said cartridge housing a plurality of optical disks;
mounting said plurality of optical disks on said plurality of turntables;
ejecting said cartridge, which is empty, to the outside;
inserting said cartridge, which is empty, when said plurality of optical disks are to be removed; and
ejecting said cartridge, in which said plurality of optical disks have been inserted, to the outside;

9. A method of operating a cartridge of a optical disk recording/reproducing device according to claim 8, comprising steps of:
inserting a cartridge housing three or more optical disks;
removing two optical disks from inside said cartridge and mounting these disks on two turntables; and
performing recording or reproducing of the two disks by a single optical head.

10. A method of operating a cartridge of an optical disk recording/reproducing device according to claim 9, further comprising a step of exchanging the positions of two other optical disks while recording/reproducing is being performed on one optical disk.
